(19) United States
(12) Patent Application Publication
(10) Pub. No.: US 2011/0208461 A1
(43) Pub. Date: Aug. 25, 2011

(54) MEASUREMENT CORRECTING SYSTEM AND METHOD THEREOF

(75) Inventors: Shih-Chieh Chao, Taipei (TW); Chih-Wen Huang, Taipei (TW); Chun-Lin Liao, Taipei (TW)

(73) Assignee: Tatung Company, Taipei (TW)

(21) Appl. No.: 12/765,857

(22) Filed: Apr. 22, 2010

(30) Foreign Application Priority Data
Feb. 24, 2010 (TW) 99105321

(51) Int. Cl. G01D 18/00

(52) U.S. Cl. 702/104

(57) ABSTRACT

A measurement correcting system including a field measuring unit and a processing unit is provided. The field measuring unit simultaneously senses a first signal to be measured and a second signal to be measured which have opposite polarities and substantially the same magnitude, and generates a first output signal and a second output signal correspondingly. The processing unit determines the first signal to be measured according to the first output signal and the second output signal. A measurement correcting method is also provided.

### CROSS-REFERENCE TO RELATED APPLICATION

This application claims the priority benefit of Taiwan application serial no. 99105321, filed on Feb. 24, 2010. The entirety of the above-mentioned patent application is hereby incorporated by reference herein and made a part of specification.

### BACKGROUND OF THE INVENTION

1. Field of the Invention

The invention relates to a measurement correcting system and a method thereof. More particularly, the invention relates to a measurement correcting system capable of improving measurement accuracy by reducing an interference noise, and a method thereof.

2. Description of Related Art

It is important to correctly measure a near-field intensity during product development and scientific research. However, during the measurement, an environmental noise is generally infiltrated into a signal wire connected to a measuring probe through coupling, and is superposed to a measuring signal of the probe which results in errors that cannot be ignored. To obtain an accurate measurement value, the influence of the coupled noise has to be eliminated.

According to a conventional method, a plurality of ferrite cores is added to a transmission line to filter a common mode noise. Moreover, Taiwan Patent No. 1224420 also discloses a method for suppressing the noise interference, by which a transmission line is connected to a common mode noise filtering circuit in series to reduce the influence of the environmental noise. However, the filtering effects of the above two methods are limited within certain bands, so that only a part of the correction effect can be achieved.

### SUMMARY OF THE INVENTION

The invention is directed to a measurement correcting system and a method thereof, which are used for reducing an influence of environmental interference noise generated during a measurement process.

The invention provides a measurement correcting system including a field measuring unit and a processing unit. The field measuring unit simultaneously senses a first signal to be measured and a second signal to be measured, and correspondingly generates a first output signal and a second output signal, wherein the first signal to be measured and the second signal to be measured have opposite polarities and substantially the same magnitude. The processing unit determines the first signal to be measured according to the first output signal and the second output signal.

In an embodiment of the invention, the field measuring unit includes a first field measuring probe and a second field measuring probe. The first field measuring probe senses the first signal to be measured, and the second field measuring probe senses the second signal to be measured.

In an embodiment of the invention, the field measuring unit further includes a first transmission line and a second transmission line. The first transmission line is electrically connected between the first field measuring probe and the processing unit. The second transmission line is electrically connected between the second field measuring probe and the processing unit. Moreover, the first transmission line and the second transmission line have the same size and length, and are arranged in parallel, so that the first signal to be measured and the second signal to be measured that are measured by the field measuring unit have substantially the same magnitude.

In an embodiment of the invention, the first field measuring probe and the second field measuring probe are arranged in minor symmetric, so that the first signal to be measured and the second signal to be measured that are measured by the field measuring unit have opposite polarities.

In an embodiment of the invention, the processing unit calculates a difference between the first output signal and the second output signal, and divides the difference by two, so as to obtain the first signal to be measured.

In an embodiment of the invention, the processing unit calculates an arithmetic average of the first output signal and the second output signal to obtain an interference noise.

In an embodiment of the invention, the interference noise includes a common mode signal and a differential mode signal.

The invention also provides a measurement correcting method. The measurement correcting method can be described as follows. A first signal to be measured and a second signal to be measured are simultaneously sensed and a first output signal and a second output signal are correspondingly generated, wherein the first signal to be measured and the second signal to be measured have opposite polarities and substantially the same magnitude. Then, the first signal to be measured is determined according to the first output signal and the second output signal.

In an embodiment of the invention, a method for simultaneously sensing the first signal to be measured and the second signal to be measured includes arranging a first field measuring probe and a second field measuring probe of a field measuring unit in minor symmetric, so as to measure the first signal to be measured and the second signal to be measured that have opposite polarities.

In an embodiment of the invention, a method for simultaneously sensing the first signal to be measured and the second signal to be measured includes arranging a first transmission line and a second transmission line of the field measuring unit in parallel, so as to measure the first signal to be measured and the second signal to be measured that have substantially the same magnitude, wherein the first transmission line and the second transmission line are respectively electrically connected to the first field measuring probe and the second field measuring probe, and the sizes and lengths of the first transmission line and the second transmission line are substantially the same.

In an embodiment of the invention, the step of determining the first signal to be measured according to the first output signal and the second output signal includes calculating a difference between the first output signal and the second output signal, and divides the difference by two, so as to obtain the first signal to be measured.

In an embodiment of the invention, the measurement correcting method further includes calculating an arithmetic average of the first output signal and the second output signal to obtain an interference noise.

In an embodiment of the invention, the interference noise includes a common mode signal and a differential mode signal.

According to the above descriptions, since the first output signal and the second output signal are respectively generated according to the first signal to be measured and the second signal to be measured that have opposite polarities and substantially the same magnitude, the noise interference can be removed and the first signal to be measured can be obtained by processing the first output signal and the second output signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a measurement correcting system according to an embodiment of the invention.

FIG. 2 is a flowchart illustrating a measurement correcting method according to an embodiment of the invention.

### DESCRIPTION OF THE EMBODIMENTS

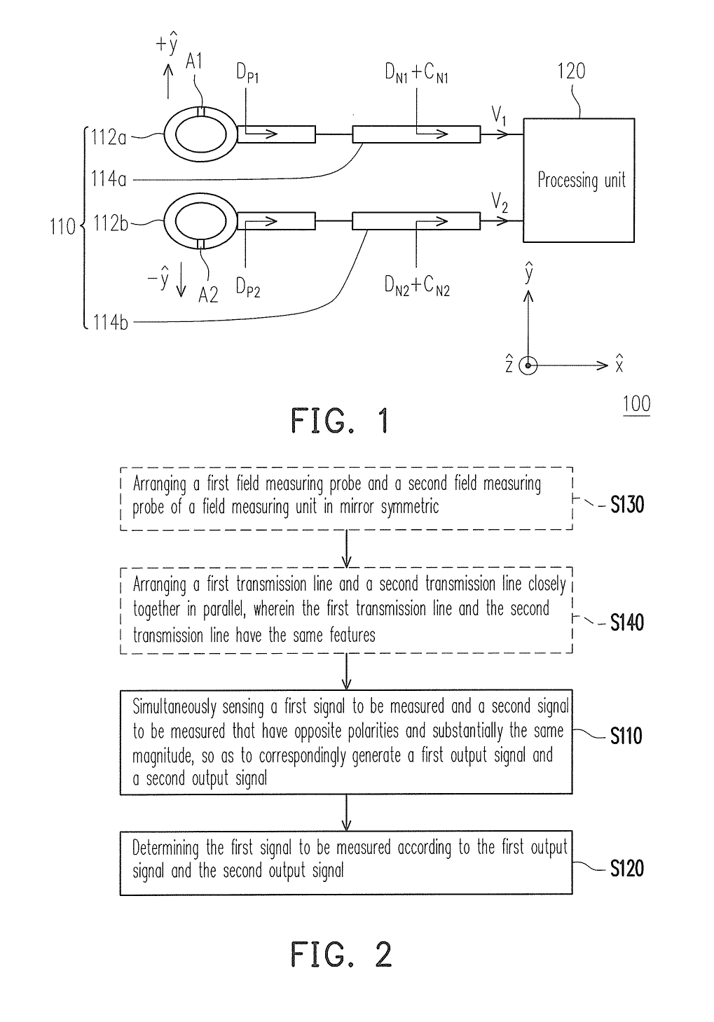

FIG. 1 is a schematic diagram illustrating a measurement correcting system according to an embodiment of the invention. Referring to FIG. 1, the measurement correcting system 100 is suitable for improving measurement accuracy by reducing an interference noise, and includes a field measuring unit 110 and a processing unit 120. The field measuring unit 110 simultaneously senses a signal to be measured D_{P1} and a signal to be measured D_{P2} that have opposite polarities and substantially the same magnitude, and correspondingly generates an output signal V₁ and an output signal V₂. The processing unit 120 determines the signal to be measured D_{P1} according to the output signal V₁ and the output signal V₂, wherein the processing unit 120 is, for example, an oscilloscope or other measuring instruments.

As shown in FIG. 1, the field measuring unit 110 includes a field measuring probe 112a and a field measuring probe 112b. When the field measuring probe 112a senses the signal to be measured D_{P1}, the field measuring probe 112b also simultaneously senses the signal to be measured D_{P2}. Moreover, the field measuring probe 112a and the field measuring probe 112b are, for example, magnetic field probes. In the other embodiments, the field measuring probe 112a and the field measuring probe 112b can also be electric field probes.

It should be noticed that in the present embodiment, the field measuring probe 112a and the field measuring probe 112b are substantially the same measuring probe, though arrangement methods thereof are different. The different arrangement methods of the measuring probes can result in a fact that the simultaneously sensed signals to be measured D_{P1} and D_{P2} may have opposite polarities. For example, in the present embodiment, the field measuring probe 112a and the field measuring probe 112b are arranged in mirror symmetric, so that the signals to be measured D_{P1} and D_{P2} simultaneously sensed by the field measuring probe 112a and the field measuring probe 112b have opposite polarities. In detail, assuming that when the field measuring probe 112a having a mark A1 facing to a +y direction senses a field with a positive polarity, the field measuring probe 112b having a mark A2 facing to a −y direction may simultaneously sense a field with a negative polarity. Namely, the field measuring unit 110 can simultaneously sense the signals to be measured D_{P1} and D_{P2} that have opposite polarities. On the other hand, a designer can adjust the relative arrangement directions of the field measuring probes according to an actual requirement, so as to ensure that the signals to be measured sensed by the two field measuring probes have opposite polarities. Namely, the arrangement methods of the field measuring probes 112a and 112b are not limited to the example of FIG. 1, and as long as the arrangement methods can ensure that the signals sensed by the two field measuring probes have opposite polarities, it is considered to be within the scope of the invention.

Referring to FIG. 1 again, the field measuring unit 110 further includes a transmission line 114a and a transmission line 114b. The transmission line 114a is electrically connected between the field measuring probe 112a and the processing unit 120, and the transmission line 114b is electrically connected between the field measuring probe 112b and the processing unit 120. The transmission lines 114a and 114b are respectively used for transmitting the signals to be measured D_{P1} and D_{P2}. In the present embodiment, the transmission line 114a and the transmission line 114b have the same features (for example, the sizes and lengths thereof are all substantially the same), and are arranged closely together in parallel, so that noise coupling degrees of the transmission lines 114a and 114b are substantially the same. In the embodiment, the distance between the transmission lines 114a and 114b preferably is less than 1 cm, more preferably is less than 1 mm. Even more preferably, the transmission lines 114a and 114b are in contact.

During the measurement process, the field measuring probes 112a and 112b or the transmission lines 114a and 114b are all interfered by external noises, so that the signal transmitted to the processing unit 120 includes the signal to be measured D_{P1} and the noise. In detail, the interference noises on the transmission lines 114a and 114b can be categorized into differential mode signals and common mode signals. The signals to be measured D_{P1} and D_{P2} that are sensed by the field measuring probes 112a and 112b are respectively transmitted to the transmission lines 114a and 114b in form of the differential mode signals. On the other hand, during the measurement process, environmental noises can also be continually coupled into the transmission lines 114a and 114b. A part of these interference noises is coupled in form of the common mode signals, and another part of the interference noises is coupled in form of the differential mode signals.

In the present embodiment, the output signals V₁ and V₂ received by the processing unit 120 can be respectively represented by:

V₁=D_{P1}+D_{N1}+C_{N1} (1)

V₂=D_{P2}+D_{N2}+C_{N2} (2)

Herein, D_{N1} and D_{N2} represent the differential mode signals of the interference noise, and C_{N1} and C_{N2} represent the common mode signals of the interference noise. As described above, since the arrangement directions of the field measuring probes 112a and 112b are different, and the transmission lines 114a and 114b have the same size and are arranged closely together in parallel, the relationships of the signals can be represented as follows:

D_{P1}=D_{P2}

D_{N1}=D_{N2}

C_{N1}=C_{N2}

Accordingly, the processing unit 120 can deduce the signal to be measured D_{P1} according to the output signals V₁ and V₂. In detail, the signal to be measured D_{P1} can be obtained by subtracting the output signal V₁ in the equation (1) and the output signal V₂ in the equation (2), so as to get the difference between the output signals V₁ and V₂, and then dividing the difference by two, i.e. V_{A}=(V₁−V₂)/2=D_{P1}=D_{P2}. Here, V_{A} is the signal to be measured D_{P1}, and the common mode signal C_{N1} and the differential mode signal D_{N1} are almost removed from output signals. In overall, since the amounts of noise coupled into the transmission lines 114a and 114b are substantially the same, the measurement correcting system 100 can effectively reduce the influence of the interference noise, and can separate the signal to be measured D_{P1} or D_{P2} from the output signal V₁ or V₂. Moreover, since the characteristic of the interference noise has no effect on the calculation of the signal to be measured, the measurement correcting system 100 of the invention is especially suitable for measuring transient signals with relative fast transition.

On the other hand, the processing unit 120 can also calculate an arithmetic average of the output signal V₁ in the equation (1) and the output signal V₂ in the equation (2) to obtain the interference noise, i.e. V_{B}=½(V₁+V₂)=D_{N1}+C_{N1}=D_{N2}+C_{N2}. Here, V_{B} represents the environmental noise, which is a superposition the common mode signal D_{N1} (or D_{N2}) and the differential mode signal C_{N1} (or C_{N2}). Moreover, in the other embodiments, the measurement correcting system 100 may include a plurality of field measuring units 110 to measure different field signals, wherein an operation method of each of the field measuring units 110 is the same as that described above, and therefore detailed description thereof is not repeated.

According to another aspect, the present embodiment also provides a measurement correcting method, which is suitable for improving measurement accuracy by reducing the influence of the interference noise. FIG. 2 is a flowchart illustrating a measurement correcting method according to an embodiment of the invention. Referring to FIG. 2, a first signal to be measured (for example, the signal to be measured D_{P1}) and a second signal to be measured (for example, the signal to be measured D_{P2}) are simultaneously sensed to correspondingly generate a first output signal (for example, the output signal V₁) and a second output signal (for example, the output signal V₂), wherein the first signal to be measured and the second signal to be measured have opposite polarities and substantially the same magnitude (step S110). Then, the first signal to be measured is determined according to the first output signal and the second output signal (step S120). Moreover, before the step S110 is executed, a first field measuring probe (for example, the field measuring probe 112a) and a second field measuring probe (for example, the field measuring probe 112b) of a field measuring unit can be arranged in mirror symmetric (step S130). In addition, before the step S110 is executed, a first transmission line (for example, the transmission line 114a) and a second transmission line (for example, the transmission line 114b) can be arranged closely together in parallel, wherein the first transmission line and the second transmission line have the same features (for example, the same size and the same length) (step S140).

In summary, in the invention, since the two signals to be measured have opposite polarities and substantially the same magnitude, by performing different mathematical operations to the two output signals, the signal to be measured and the noise interference can be separated from the two output signals, so as to obtain an accurate signal to be measured.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A measurement correcting system, comprising:
a field measuring unit, simultaneously sensing a first signal to be measured and a second signal to be measured, and correspondingly generating a first output signal and a second output signal, wherein the first signal to be measured and the second signal to be measured have opposite polarities and substantially the same magnitude; and
a processing unit, determining the first signal to be measured according to the first output signal and the second output signal.

2. The measurement correcting system as claimed in claim 1, wherein the field measuring unit comprises a first field measuring probe and a second field measuring probe, the first field measuring probe senses the first signal to be measured, and the second field measuring probe senses the second signal to be measured.

3. The measurement correcting system as claimed in claim 2, wherein the field measuring unit further comprises:
a first transmission line, electrically connected between the first field measuring probe and the processing unit; and
a second transmission line, electrically connected between the second field measuring probe and the processing unit, wherein the first transmission line and the second transmission line have the same size and the same length, and are arranged in parallel, so that the first signal to be measured and the second signal to be measured that are measured by the field measuring unit have substantially the same magnitude.

4. The measurement correcting system as claimed in claim 1, wherein the first field measuring probe and the second field measuring probe are arranged in mirror symmetric, so that the first signal to be measured and the second signal to be measured that are measured by the field measuring unit have opposite polarities.

5. The measurement correcting system as claimed in claim 1, wherein the processing unit calculates a difference between the first output signal and the second output signal, and divides the difference by two, so as to obtain the first signal to be measured.

6. The measurement correcting system as claimed in claim 1, wherein the processing unit calculates an arithmetic average of the first output signal and the second output signal to obtain an interference noise.

7. The measurement correcting system as claimed in claim 6, wherein the interference noise comprises a common mode signal and a differential mode signal.

8. A measurement correcting method, comprising:
simultaneously sensing a first signal to be measured and a second signal to be measured to correspondingly generate a first output signal and a second output signal, wherein the first signal to be measured and the second signal to be measured have opposite polarities and substantially the same magnitude; and
determining the first signal to be measured according to the first output signal and the second output signal.

9. The measurement correcting method as claimed in claim 8, wherein a method for simultaneously sensing the first signal to be measured and the second signal to be measured comprises arranging a first field measuring probe and a second field measuring probe of a field measuring unit in mirror symmetric, so as to measure the first signal to be measured and the second signal to be measured that have opposite polarities.

10. The measurement correcting method as claimed in claim 9, wherein a method for simultaneously sensing the first signal to be measured and the second signal to be measured comprises arranging a first transmission line and a second transmission line of the field measuring unit in parallel, so as to measure the first signal to be measured and the second signal to be measured that have substantially the same magnitude, wherein the first transmission line and the second transmission line are respectively electrically connected to the first field measuring probe and the second field measuring probe, and sizes and lengths of the first transmission line and the second transmission line are substantially the same.

11. The measurement correcting method as claimed in claim 8, wherein the step of determining the first signal to be measured according to the first output signal and the second output signal comprises calculating a difference between the first output signal and the second output signal, and divides the difference by two, so as to obtain the first signal to be measured.

12. The measurement correcting method as claimed in claim 8, further comprising calculating an arithmetic average of the first output signal and the second output signal to obtain an interference noise.

13. The measurement correcting method as claimed in claim 12, wherein the interference noise comprises a common mode signal and a differential mode signal.
